(19) United States
(12) Patent Application Publication
(10) Pub. No.: US 2013/0002761 A1
(43) Pub. Date: Jan. 3, 2013

(54) INKJET RECORDING METHOD AND INKJET RECORDING APPARATUS

(75) Inventor: Dan Iwata, Kawasaki-shi (JP)

(73) Assignee: CANON KABUSHIKI KAISHA, Tokyo (JP)

(21) Appl. No.: 13/536,727

(22) Filed: Jun. 28, 2012

(30) Foreign Application Priority Data
Jul. 1, 2011 (JP) 2011-147372

(51) Int. Cl. B41J 23/00

(52) U.S. Cl. 347/37

(57) ABSTRACT

A recording method includes recording while performing a scan by a carriage mounted with a recording head that discharges ink, changing postures of the carriage at each of a plurality of positions in a scanning direction such that changes in the postures are reduced at the plurality of positions.

### BACKGROUND OF THE INVENTION

1. Field of the Invention

The present invention relates to an inkjet recording method and an inkjet recording apparatus.

2. Description of the Related Art

Inkjet recording apparatus that has recently come into wide use forms an image by dots of ink droplets discharged toward a recording medium. The quality of a resultant image depends on an adhesion position (recording position) and density of the dots. To record an image of high quality, the inkjet recording apparatus requires high accuracy in the recording position. However, a recording head and other components constituting inkjet recording apparatus in themselves have dimension error and there is assembly error generated during assembling thereof. The errors cannot be completely avoided. These errors results in a positional deviation of a recording position, which become one factor leading to poor image quality.

Thus, techniques have been discussed to correct the positional deviation of the recording position unique to individual recording head or recording apparatus. For example, Japanese Patent Application Laid-Open No. 2000-296648 and Japanese Patent Application Laid-Open No. 2004-284124 each discusses a method of adjusting a timing to supply image data to a recording head to correct a positional deviation of a recording position in the forward and backward moving of a reciprocating recording head, or to correct a positional deviation of a recording position between a plurality of recording heads. In these methods, a timing to discharge ink droplets from a recording head is changed to correct the positional deviation of the recording position. Japanese Patent Application Laid-Open No. 2008-183903 discusses a method to correct a positional deviation of a recording position in the sub-scanning direction by adjusting a position (or an angle) to attach the recording head onto a carriage in the direction intersecting with the main scanning direction. The methods by the above Japanese Patent Application Laid-Open No. 2000-296648, No. 2004-284124, and No. 2008-183903 each basically perform correction to reduce average positional deviation of recording positions in entire main scanning area.

In recent years, the inkjet recording apparatuses have been demanded to provide high quality images, and thereby any decrease in image quality due to a positional deviation of a recording position associated with a postural change of a carriage that during scanning has become a problem to solve. A postural change of a carriage adversely affects the discharging angle of ink droplets from a recording head toward a recording medium, that is, a velocity of ink droplets. The positional deviation of the recording position due to a postural change of a carriage during scanning cannot be corrected accurately by the methods according to the above Japanese Patent Application Laid-Open No. 2000-296648, No. 2004-284124, and No. 2008-183903.

There has been a growing need for a relatively large inkjet recording apparatus that enables recording onto a large-size recording medium. In a relatively-small inkjet recording apparatus, a postural change of a recording head is small, which causes almost no problem in image formation. However, a larger inkjet recording apparatus has a longer distance for scanning by a carriage, and thereby a postural change of a recording head due to mechanical factors such as a slight curve of a rail that guides and supports the carriage in its main scanning direction becomes relatively larger, which can cause a problem of poor image quality.

Japanese Patent Application Laid-Open No. 2009-143152 discusses a method to appropriately correct recording positions at individual carriage positions even when a positional deviation of a recording position changes depending on the positions of the carriages each having a recording head. In the method, test patches are recorded at a plurality of positions within a main scan area, and the recorded test patches are used to measure positional deviations of recording positions with respect to each recording position. Based on the measured positional deviations of recording positions with respect to each recording position, correction is performed.

As discussed in Japanese Patent Application Laid-Open No. 2009-143152, in the method of performing correction by measuring positional deviations of recording positions using recorded test patches, not only a postural change of a carriage is reflected in the corrected values. In other words, a number of elements obtained in measuring positional deviations of recording positions are reflected in the corrected values, such as the state of a recording medium when the test patches are recorded, and the surface flatness of a platen that is located under the recording medium to support thereof. To correct positional deviations of recording positions due to postural changes of carriages with high accuracy, decrease in the uncertain elements and direct detection of the postural changes of carriages are required.

### SUMMARY OF THE INVENTION

The present invention is directed to an inkjet recording apparatus and an inkjet recording method that suppress a positional deviation of a recording position due to a postural change of carriage during scanning to enable to improve image quality.

According to an aspect of the present invention, an inkjet recording method is provided. In the method, recording is performed while a scan is performed by a carriage mounted with a recording head to discharge ink. The method includes a step of correcting respective postures of the carriage at each of positions to reduce postural changes of the carriage at the plurality of the positions in its scanning direction.

According to another aspect of the present invention, an inkjet recording apparatus is provided. In the apparatus, recording is performed while a scan is performed by a carriage mounted with a recording head to discharge ink. The apparatus includes a carriage position detection unit configured to detect a position of the carriage in the scanning direction during the scanning, and a carriage position correcting unit configured to correct a posture of the carriage according to the positions of the carriage in the scanning direction, based on the detection result of the carriage position detection unit.

According to the present invention, positional deviation of recording position due to a postural change of a carriage during scanning can be suppressed, recording quality can be improved, and lower manufacturing cost can be achieved.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a perspective view illustrating a schematic structure of an inkjet recording apparatus according to an exemplary embodiment of the present invention.

FIG. 2 schematically illustrates postural change of a carriage of the inkjet recording apparatus in FIG. 1.

FIG. 3 is a plan view illustrating a carriage of the inkjet recording apparatus in FIG. 1.

FIG. 4 is a side view illustrating a carriage of the inkjet recording apparatus in FIG. 1.

FIG. 5 is a block view illustrating a control unit of the inkjet recording apparatus in FIG. 1.

FIG. 6 illustrates a flowchart of an inkjet recording method according to an exemplary embodiment of the present invention.

FIG. 7A is a graph illustrating the relationship between positions of a carriage and rotation angles, before correction according to an inkjet recording method of an exemplary embodiment of the present invention.

FIG. 7B is a graph illustrating the relationship between positions of a carriage and rotation angles, after correction.

FIG. 8 is a side view illustrating a carriage of an inkjet recording apparatus according to another exemplary embodiment of the present invention.

FIG. 9A is a graph illustrating the relationship between positions of a carriage and rotation angles, before correction according to an inkjet recording method of another exemplary embodiment of the present invention.

FIG. 9B is a graph illustrating the relationship between positions of a carriage and rotation angles, after correction.

### DESCRIPTION OF THE EMBODIMENTS

Various exemplary embodiments, features, and aspects of the invention will be described in detail below with reference to the drawings.

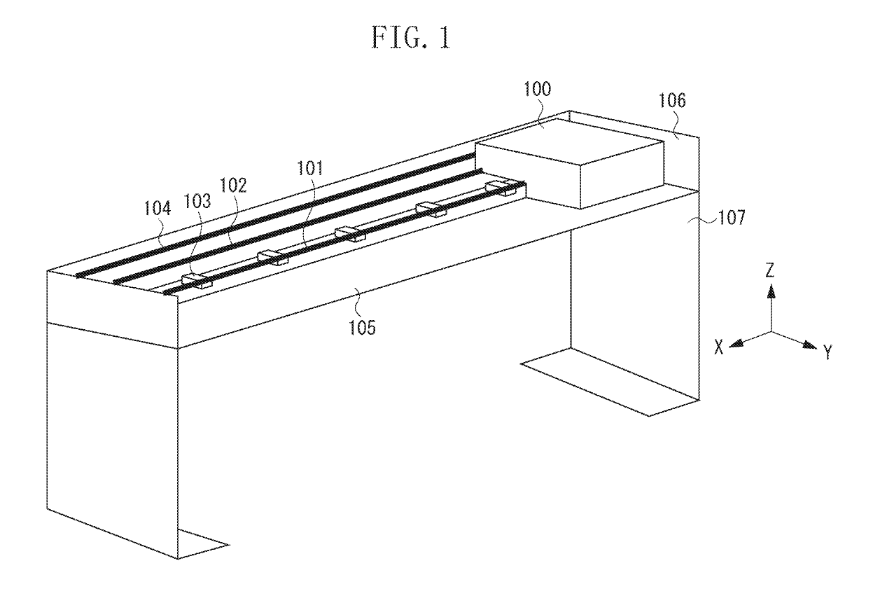

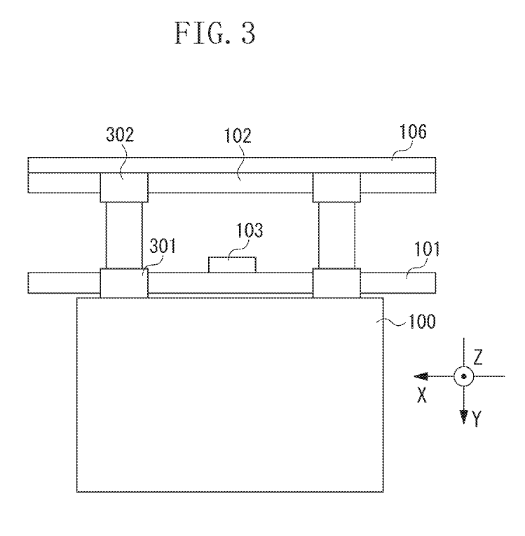

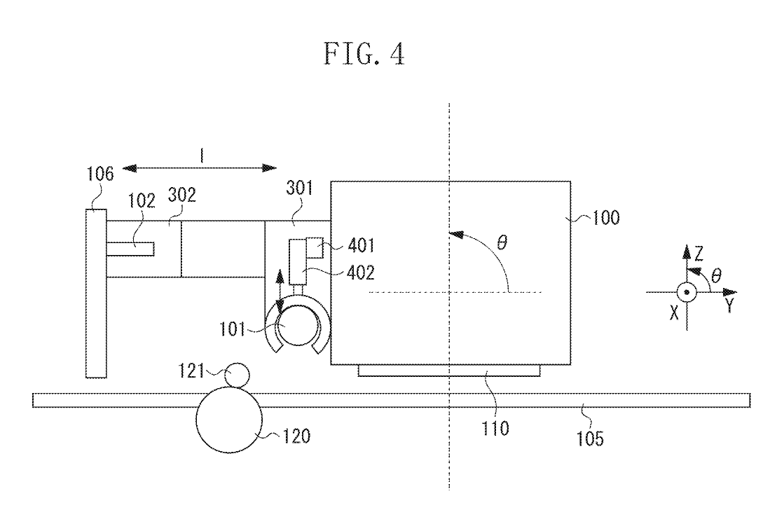

FIG. 1 is a perspective view illustrating a schematic structure of a relatively large inkjet recording apparatus according to an exemplary embodiment of the present invention. The inkjet recording apparatus includes an upper frame 106 supported by a leg-shaped lower frame 107. Inside of the upper frame 106, a main rail 101, a sub rail 102, a carriage encoder 104 (carriage position detection unit), and a platen 105 are arranged in parallel to one another extending in amain scanning direction. The main rail 101 is fixed to the upper frame 106 at its both ends, and is supported from underneath by a plurality of supporting members 103 to prevent deflection of the main rail 101 at its middle portion due to its own weight. The main rail 101 supports a carriage 100 movable in the main scanning direction (i.e., in the x direction). The sub rail 102 is fixed to the upper frame 106 throughout its length to prevent its deflection. The sub rail 102 serves to hold the posture of the carriage 100 guided by the main rail 101. As illustrated in FIGS. 3 and 4, the main rail 101 and the sub rail 102 are connected to each other using two pairs of carriage bearing members 301 and 302 that are connected to the carriage 100.

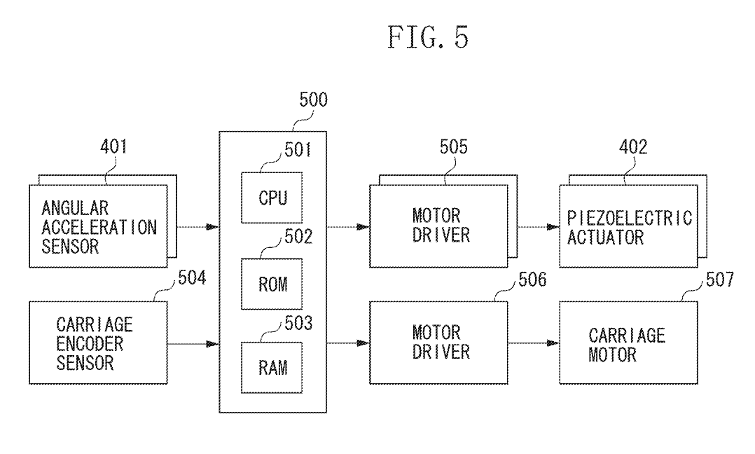

The carriage 100 is mounted with a recording head 110 that discharges ink droplets according to recording data, and as illustrated in FIGS. 3 and 4, is connected to the sub rail 102 using two sub-rail supporting members 302. The carriage 100 is driven by a carriage motor 507 (see FIG. 5) to scan back and forth in the main scanning direction (the x direction) while being guided by the main rail 101 and the sub rail 102. The carriage 100 includes a carriage encoder sensor 504 (see FIG. 5), and the carriage encoder sensor 504 reads a mark of the carriage encoder 104 extending in the main scanning direction, so that a position of the carriage 100 can be detected. In other words, the carriage encoder 104 and the carriage encoder sensor 504 constitute a carriage position detection unit of the present exemplary embodiment. Other methods of carriage position detection, both passive and active, are well known in the art and may be used without going beyond the scope of the present invention as recited in the claims.

The platen 105 includes a plurality of ribs to support from lower side a recording medium inserted into the upper frame 106, at a position where the recording head 110 mounted on the carriage 100 can record data on the recording medium. The recording medium is pinched between a conveyance roller 120 and a pinch roller 121 to be conveyed on the platen 105 in the sub-scanning direction (in the y direction). The platen 105 and the rollers 120 and 121 are mounted on the lower frame 107.

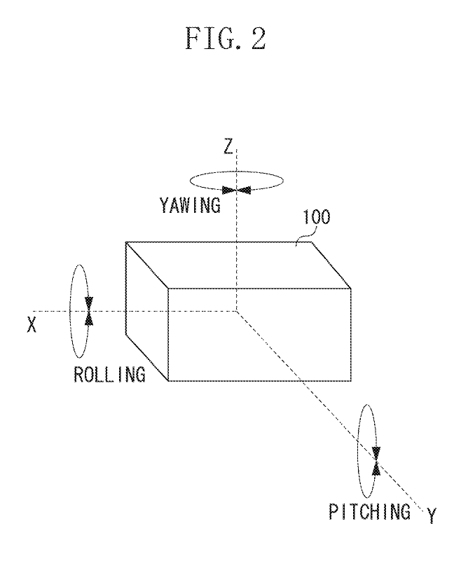

Postural change of the carriage 100 of the present exemplary embodiment will be described with reference to FIGS. 2 to 4. The sub rail 102 is fixed to the upper frame 106, and is kept in a straight line with relatively high accuracy, but the main rail 101 may be slightly curved toward the z direction (in the upward or downward direction). In this case, the height difference of the main rail 101 itself causes postural change (rolling) of the carriage 100 rotating around the sub rail 102 as a center. Almost all of the weight of the carriage 100 is received by the main rail 101, resulting in deflection of the main rail 101. The deflection leads to postural change of the carriage 100 and also the recording head 110 around the two pair of the carriage bearing members 301 and 302 as pivot points. The deflection of the main rail 101 can be corrected to some degree by the supporting members 103, but the manufacturing process of the main rail 101 accompanies slight but unavoidable deflection.

Thus, in the present exemplary embodiment, as illustrated in FIG. 4, each of the carriage bearing members 301 is mounted with an angular acceleration sensor (gyroscope) 401 as a carriage posture detection unit that detects rolling of the carriage 100. The angular acceleration sensor (carriage posture detection unit) 401 can detect an angle and angular velocity of an object, and is a measuring instrument that may be utilized to detect hands movement in using a digital camera or a mobile phone. In the present exemplary embodiment, the angular acceleration sensor 401 measures a rotation angle θ of the carriage 100.

Each of the carriage bearing members 301 is further mounted with a piezoelectric actuator 402 as a carriage posture correction unit. Actuation of the piezoelectric actuator 402 makes the carriage bearing members 301 attached to the carriage 100 move in the z direction relative to the carriage 100. In other words, the piezoelectric actuator 402 moves the carriage bearing members 301 relative to the carriage 100 in the direction intersecting with the scanning direction. The position of abutting portion where the bearing member 301 abuts on the main rail 101 moves relative to the carriage 100 in the direction intersecting with the scanning direction. As a result, the carriage 100 can move relative to the main rail 101. The carriage 100 rotates around an axis extending in the scanning direction.

FIG. 5 is a block view illustrating a control unit of the inkjet recording apparatus of the present exemplary embodiment. A controller 500 as a main control unit includes a central processing unit (CPU) 501, a read only memory (ROM) 502, and a random access memory (RAM) 503. The CPU 501 is a microcomputer, for example. The ROM 502 stores programs, tables required, and other fixed data therein. The RAM 503 has a work area. The angular acceleration sensors 401, the carriage encoder sensor 504, and motor drivers 505 and 506 are connected to controller 500. The motor driver 505 drives the piezoelectric actuator 402, and the motor driver 506 drives the carriage motor 507.

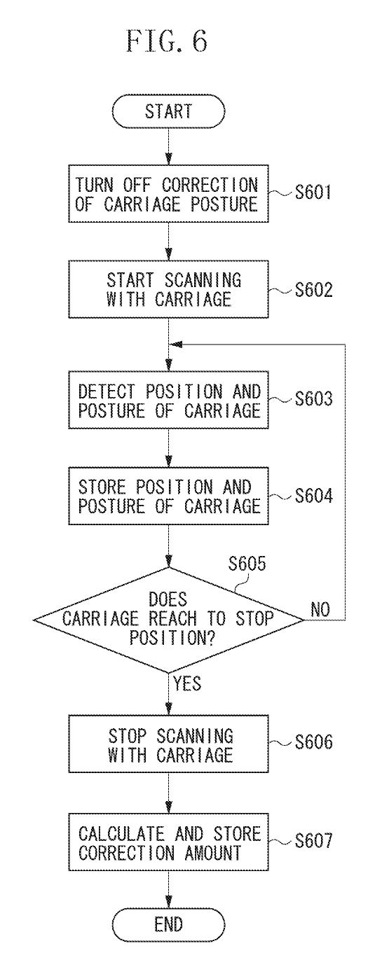

The inkjet recording apparatus of the present exemplary embodiment, when turned on, performs adjustment of carriage posture to calculate a correction value for the posture of the carriage 100. FIG. 6 illustrates a flowchart for the adjustment of carriage posture.

The CPU 501 starts an adjustment of carriage posture, and then in step S601, the CPU 501 does not correct the posture of the carriage 100 using the piezoelectric actuator 402, and in step S602, the CPU 501 starts scanning by moving the carriage 100. Throughout the scanning by the carriage 100, the carriage encoder sensor 504 reads the carriage encoder 104 to obtain positions of the carriage 100 in the x direction (in the scanning direction). In step S603, each angular acceleration sensor 401 measures a rotation angle θ of the carriage 100 to figure out a posture of the carriage 100. In step S604, the RAM 503 stores the resultant data: the positions of the carriage 100 in the x direction and the postures of the carriage 100. In step S605, the carriage 100 reaches to a scan-completed position (stop position). In step S606, the scan by the carriage 100 is stopped. In step S607, based on the data (detection results) stored in the RAM 503, correction data is generated to cancel the postural change of the carriage 100. More specifically, an additional rotation angle dθ at each position is calculated, the rotation angle dθ being necessary to maintain the angle θ of the center line of the carriage 100 in the z direction relative to the y direction (the conveyance direction of a recording sheet) at a target a predetermined angle θt: dθ=θt−θ. The additional rotation angle dθ corresponds to a corrected rotation angle. An amount of displacement (correction amount) of each carriage bearing member 301 in the z direction by the piezoelectric actuator 402 is calculated, the amount of displacement being necessary to rotate the carriage 100 by the corrected rotation angle dθ. The correction amount dz is stored in the ROM 502.

In actual recording, while the carriage 100 is scanning, the carriage bearing members 301 are moved by the correction amount dz for each position in the x direction, by the piezoelectric actuator 402 in the z direction.

The correction amount dz moved by the piezoelectric actuator 402 to rotate the carriage 100 by the corrected rotation angle dθ can be expressed by the following equation 1, where l is a distance in the y direction from the contact portion between the sub-rail supporting member 302 and the sub rail 102 to the contact portion between the carriage bearing member 301 and the main rail 101.

dz=l·tan dθ≈l·dθ [Equation 1]

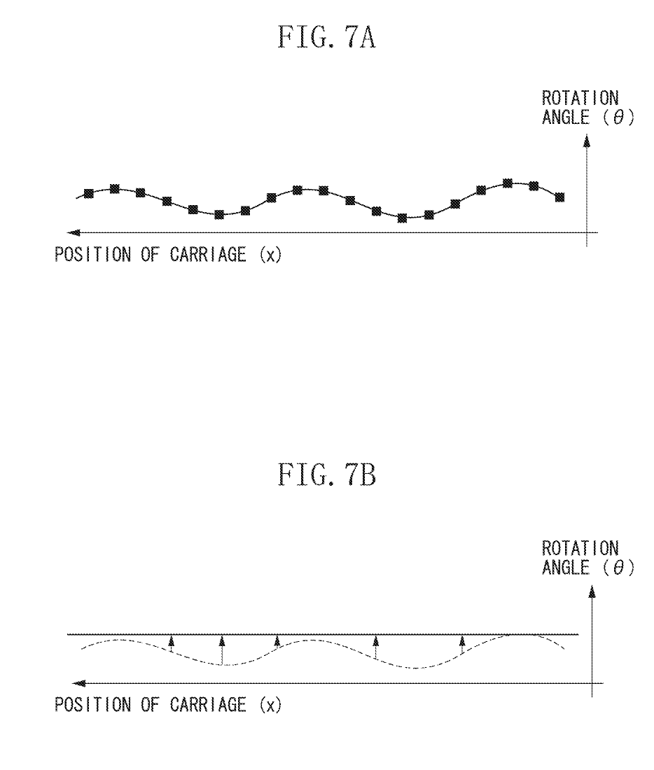

FIGS. 7A and 7B illustrate specific examples of the above described carriage posture adjustment. FIG. 7A illustrates the relationship between the positions dx of the carriage 100 in the x direction and the rotation angles θ that are intermittently measured during scanning by the carriage 100. As illustrated in FIG. 7A, the rotation angles θ vary depending on the positions along the x direction. The rotation angles θ are corrected to the maximum value to make the angles θ uniform. FIG. 7B schematically illustrates the rotation angles θ before correction by a broken line, and the rotation angles θ after correction by a solid line, with several corrected rotation angles dθ by arrows.

A table is generated, and is stored in the RAM 503 or the ROM 502, the table containing a plurality of positions x1, x2, . . . and xn of the carriage 100 in the scanning direction at every predetermined distance, and correction amounts dz1, dz2, . . . and dzn corresponding to the positions respectively. In operation of the carriage 100, as the carriage 100 passes the positions x1, x2, . . . and xn, the correction amounts dz1, dz2, . . . and dzn corresponding to the positions are read respectively, so that the piezoelectric actuator 402 moves the carriage bearing member 301 by the correction amount dzn in the z direction.

Alternatively, a rotation angle θ of the carriage 100 may be measured every time when the carriage 100 moves a predetermined distance, and a correction amount dz necessary for the measured rotation angle θ is calculated, so that the piezoelectric actuator 402 is driven to move the carriage bearing member 301 according to the calculation.

The posture correction of the carriage 100 results in posture correction of the recording head 110 that is fixedly mounted to the carriage 100.

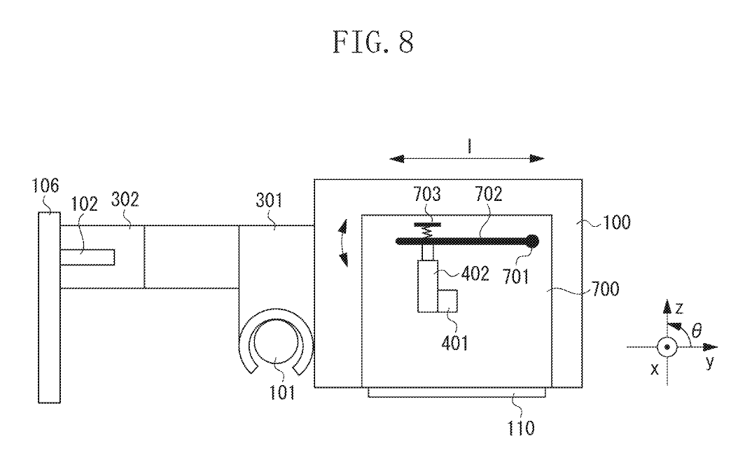

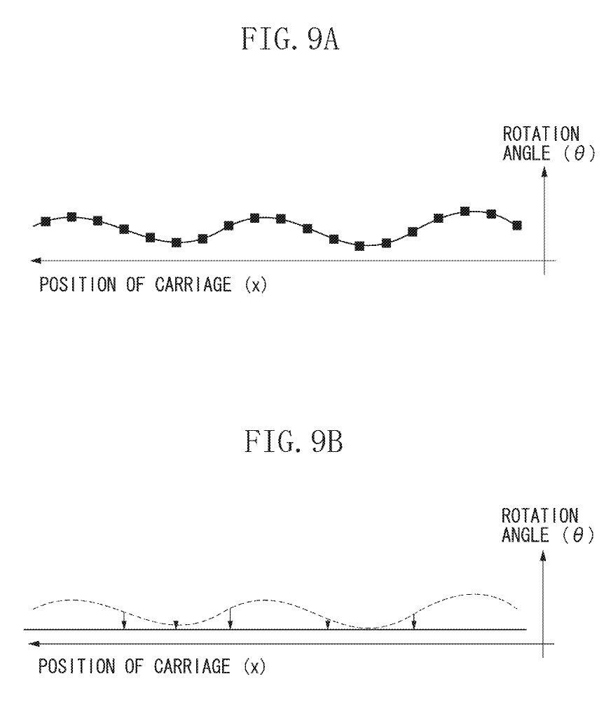

Another exemplary embodiment of the present invention will be described with reference to FIGS. 8 and 9. The structure and method similar to those in the above exemplary embodiment will not be described, and only the difference between the exemplary embodiments will be described.

FIG. 8 is a side cross sectional view illustrating the carriage 100 of the present exemplary embodiment. The carriage 100 of the present exemplary embodiment includes a recording head accommodating unit 700 configured to accommodate the recording head 110 therein. The recording head accommodating unit 700 is supported rotatably by the carriage 100 through a pin 701. The pin 701 is unrotatably fixed to the recording head accommodating unit 700. An arm 702 is fixedly secured to the pin 701 and the recording head accommodating unit 700, the pin 701, and the arm 702 integrally rotate relative to the carriage 100. The angular acceleration sensors 401 and the piezoelectric actuators 402 are fixed to the carriage 100 on the both sides of the recording head accommodating unit 700. The angular acceleration sensors 401 measure a rotation angle θ of the carriage 100. The piezoelectric actuators 402 are connected to the arm 702 that rotates integrally with the recording head accommodating unit 700 to be capable of rotating the recording head accommodating unit 700 (and the recording head 110) via the arm 702 in the direction θ. A compression spring 703 is interposed between the arm 702 and the carriage 100, and urges and biases the arm 702 toward the piezoelectric actuator 402 from the side opposite the piezoelectric actuator 402 across the arm 702. The recording head accommodating unit 700 stops moving at a position where the force applied by the piezoelectric actuator 402 and the force of the spring 703 are balanced.

In the present exemplary embodiment also, a posture of the recording head 110 is adjusted in a manner substantially similar to that illustrated in FIG. 6. In addition, in the present exemplary embodiment, the carriage 100 is aligned with a posture having a minimum rotation angle θ. The correction amount dz moved by the piezoelectric actuator 402 to correct a rotation angle θ of the carriage 100 in the present exemplary embodiment can be expressed by the following equation 2, where l′ is a distance in the y direction from the pin 701 to a contact point between the piezoelectric actuator 402 and the arm 702.

dz=l′·tan dθ≈l′·dθ [Equation 2]

FIGS. 9A and 9B illustrate specific examples of the carriage posture adjustment of the present exemplary embodiment. FIG. 9A illustrates the relationship between the positions dx of the carriage 100 in the x direction and the rotation angles θ that are intermittently measured during scanning by the carriage 100. In the present exemplary embodiment, the rotation angles θ are corrected to be aligned with the minimum value thereof. FIG. 9B schematically illustrates the rotation angles θ before correction by a broken line, and the rotation angles θ after correction by a solid line, with several corrected rotation angles dθ by arrows.

As described in the two exemplary embodiments, according to the present invention, in a recording apparatus that records images on a printing medium by moving the carriage 100 mounted with the recording head 110 to discharge ink, higher recording quality can be provided. Specifically, any postural change of the carriage 100 due to curving of the main rail 101 supporting the carriage 100 can be suppressed to move the carriage 100 for scanning at a constant posture. As a result, any positional deviation of a recording position can be restrained, improving recording quality.

Such suppression of postural change of the carriage 100 can accommodate a slight curve of the main rail 101. As a result, as well as the improvement in recording quality, a degree of freedom of selection for the material of members such as the main rail 101 can be increased. In addition, further improvement in assembly accuracy is not necessarily required, leading to decreases in the manufacturing cost and product price of the apparatus.

The present invention is not limited to correction of postural change of a carriage in the z direction (angle θ), and is effective to correction of postural change of a carriage in other directions. Especially, the present invention is effective when the carriage 100 moves along a plane orthogonal to the scanning direction (the x direction) of the carriage 100. The carriage 100 may move along a plane orthogonal to the scanning direction (the x direction) of the carriage 100 by moving the supporting members 103 that support the main rail 101 guiding the carriage 100.

In the above described exemplary embodiments, the adjustment of carriage posture is performed when the inkjet recording apparatus is turned on, but may be performed at another timing such as when a user instructs each time to perform the adjustment.

The postures of the carriage 100 can be corrected by aligning to the rotation angle θ to a maximum value, a minimum value, or an average value. Furthermore, a feedback control may be used such that postural changes of the carriage 100 can be sequentially detected and corrected during scanning by the carriage 100 at the time of actual recording.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-147372 filed Jul. 1, 2011, which is hereby incorporated by reference herein in its entirety.

What is claimed is:

1. An inkjet recording method, comprising:
recording while performing a scan by a carriage mounted with a recording head that discharges ink; and
changing postures of the carriage at each of a plurality of positions in a scanning direction such that changes in the postures are reduced at the plurality of positions.

2. The method according to claim 1, further comprising storing correction data to reduce the changes in the postures at each of the positions in the scanning direction, wherein steps for correcting each of the postures of the carriage are performed based on the correction data.

3. The method according to claim 1, wherein steps for correcting the respective postures of the carriage includes moving the carriage along a plane orthogonal to the scanning direction.

4. An inkjet recording apparatus, comprising:
a carriage on which a recording head that discharges ink is mounted;
a detection unit configured to detect a position of the carriage in a scanning direction; and
a correction unit configured to correct a posture of the carriage according to the position detected by the detection unit.

5. The inkjet recording apparatus according to claim 4, wherein the correction unit is configured to be provided to the carriage, and move an abutting portion abutting on a rail that supports the carriage, in a direction intersecting with the scanning direction of the carriage.

6. The inkjet recording apparatus according to claim 4, wherein the correction unit is configured to be provided to at least one supporting member supporting a rail that supports the carriage, and moves the rail in a direction intersecting with the scanning direction of the carriage.

7. The inkjet recording apparatus according to claim 4, further comprising a storage unit configured to store correction data that is used to correct a change in a posture of the carriage at a plurality of positions in the scanning direction of the carriage, and wherein the correction unit is configured to correct the posture of the carriage based on the correction data.

8. The inkjet recording apparatus according to claim 4, wherein the correction unit is configured to correct an angle of the carriage relative to a direction intersecting with the scanning direction of the carriage.

9. The inkjet recording apparatus according to claim 4, wherein the correction unit includes a piezoelectric actuator.

10. A recording apparatus, comprising:
a mechanism to record while performing a scan by a recording head that discharges ink;
a detection unit configured to detect a position of the recording head in a scanning direction; and
a correction unit configured to correct a posture of the recording head according to the position detected by the detection unit.

11. The inkjet recording apparatus according to claim 10, wherein the correction unit corrects the posture by moving the recording head in a direction that is not in the scanning direction.

12. The inkjet recording apparatus according to claim 10, further comprising:
a first member that provides mechanical support between the recording head and a first rail;
a second member that provides mechanical support between the recording head and a first rail;
wherein the posture is corrected by moving the first member relative to the first rail in a direction that is not in the scanning direction; and
wherein the second member is not moved to correct the posture.

13. The inkjet recording apparatus according to claim 10, further comprising:
a plurality of members that provide mechanical support between the recording head and a corresponding rail among a plurality of rails, wherein each member of the is capable of being moved relative to its corresponding rails; and
wherein the posture is corrected by moving the members relative to the rails in directions that are not in the scanning direction.

14. The inkjet recording apparatus according to claim 10, wherein the posture is adjusted by rotating the recording head relative to a carriage holding the recording head.

15. The inkjet recording apparatus according to claim 10, wherein the posture is adjusted by rotating a carriage holding the recording head relative to a rail.

16. The inkjet recording apparatus according to claim 4, further comprising:
a rail that supports the carriage;
a supporting member that provides mechanical support between the rail and the inkjet recording apparatus; and
wherein the correction unit is configured to move the rail in a direction not in the scanning direction.
